(19) United States
(12) Patent Application Publication
(10) Pub. No.: US 2013/0083664 A1
(43) Pub. Date: Apr. 4, 2013

(54) REMOTE MANAGEMENT HARDWARE PLATFORM FOR SITE MONITORING WITH SMART BLOCK I/O DEVICE

(71) Applicants: Jeffrey T. Harris, Dublin, OH (US); Joel M. Tamkin, Westervillo, OH (US); Kyle Jordan, Circleville, OH (US); James Morrissey, Santa Clara, CA (US)

(72) Inventors: Jeffrey T. Harris, Dublin, OH (US); Joel M. Tamkin, Westervillo, OH (US); Kyle Jordan, Circleville, OH (US); James Morrissey, Santa Clara, CA (US)

(21) Appl. No.: 13/231,356

(22) Filed: Sep. 13, 2011

Related U.S. Application Data
(60) Provisional application No. 61/382,070, filed on Sep. 13, 2010.

(51) Int. Cl. H04W 24/00

(52) U.S. Cl. CPC H04W 24/00
USPC 370/241

(57) ABSTRACT

A system for monitoring a remote site includes a remote management module including a processor and memory configured to receive and store definitions of the measurements and alarms, and a communication system for reporting collected measurements and alarms to upstream systems, and at least one remote measuring block including port connectors for communicating the remote measuring block with downstream collection devices that collect measurements and alarms at the remote site. A networking connection such as an Ethernet connection is provided between the remote management module and the remote measuring block for transferring data therebetween. The blocks can be located near terminations of the collection devices to reduce the amount of required cabling. The remote management module can store configuration and operating software for the blocks so that new blocks can be automatically configured upon replacement of failed blocks.

### CROSS-REFERENCE TO RELATED APPLICATIONS

This application claims the priority benefit of U.S. Provisional Patent Application No. 61/382,070 filed on Sep. 13, 2010, the disclosure of which is expressly incorporated herein in its entirety by reference.

### STATEMENT REGARDING FEDERALLY SPONSORED RESEARCH

Not Applicable

### PARTIES TO JOINT RESEARCH AGREEMENT

Not Applicable

### REFERENCE TO APPENDIX

Not Applicable

### FIELD OF THE INVENTION

The field of the invention generally relates to management systems for monitoring and controlling remote sites and equipment and, more specifically, relates to such systems used to monitor and control cell sites of wireless telecommunication networks.

### BACKGROUND OF THE INVENTION

Wireless telecommunication networks typically have central management stations which manage and control a plurality of remote sites. Devices at the remote sites collect analog sensor measurements and provide that information to the central management station. For example, see U.S. Pat. Nos. 6,640,101 and 7,567,519 and U.S. patent applications Ser. Nos. 12/950,265, 12/964,291, and 13,078,055, the disclosures of which are each expressly incorporated herein in their entireties by reference.

Remote site devices typically fall into two categories: those specifically introduced to monitor one specific function, and those which are extendable to provide a wide range of collection points. The tradeoff between both types of devices becomes a question of need and price. In both categories, however, the solutions require extensive equipment, installation, and configuration which is costly, This is not only the case for initial installation but also for upgrade and replacement situations. Accordingly, there is a need in the art for improved equipment design to allow for more economical solutions.

### SUMMARY OF THE INVENTION

Disclosed herein is a system for monitoring and controlling remote sites and equipment which addresses one or more issues in the related art. Disclosed is a system for monitoring a remote site comprising, in combination, a remote management module including a processor and memory configured to receive definitions of measurements and alarms to be collected at the remote site and to store the definitions of the measurements and alarms, and a communication system for reporting collected measurements and alarms to upstream systems located away from the remote site, and at least one remote measuring block including a processor and memory configured to receive from the remote management module at least one of the definitions of measurements and alarms to be collected at the remote site and to store the at least one of the definitions of the measurements and alarms, and a plurality of port connectors for communicating the processor of the remote measuring block with downstream collection devices that collect measurements and alarms at the remote site. A networking connection is provided between the remote management module and the remote measuring block for transferring data therebetween.

Also disclosed is a system for monitoring a remote site comprising, in combination, a remote management module including a processor and memory configured to receive definitions of measurements and alarms to be collected at the remote site and to store the definitions of the measurements and alarms, and a communication system for reporting collected measurements and alarms to upstream systems located away from the remote site, and at least one remote measuring block including a plurality of port connectors for connection to downstream collection devices that collect measurements and alarms at the remote site. The remote management module and the remote measuring block are packaged as separate units and are at separate locations of the remote site. A networking connection is provided between the remote management module and the remote measuring block transferring data therebetween.

Also disclosed is a system for monitoring a remote site comprising, in combination, a remote management module including a processor and memory configured to receive definitions of measurements and alarms to be collected at the remote site and to store the definitions of the measurements and alarms, and a communication system for reporting collected measurements and alarms to upstream systems located away from the remote site, and at least one remote measuring block including a processor and memory configured to receive from the remote management module at least one of the definitions of measurements and alarms to be collected at the remote site and to store the at least one of the definitions of the measurements and alarms, and a plurality of port connectors for communicating the processor of the remote measuring block with downstream collection devices that collect measurements and alarms at the remote site. A networking connection is provided between the remote management module and the remote measuring block for transferring data therebetween. All configurations for the devices connected to the remote measuring block are stored in the remote management module so that the remote measuring block can be replaced without reconfiguration.

From the foregoing disclosure and the following more detailed description of various preferred embodiments it will be apparent to those skilled in the art that the present invention provides a significant advance in the technology of management systems for monitoring and controlling remote sites and equipment. Particularly, the invention(s) disclosed herein provides a system with the hardware and feature set required for small scaled but expanding installations in a cost effective manner. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a diagrammatic view of a system for remote site monitoring according to the present invention.

FIG. 2 is a diagrammatic view of the remote site of FIG. 1 showing a remote management module with a plurality of Remote management blocks or Smart Block I/O devices connected thereto.

FIG. 3 is a block diagram showing connections of the remote management module and one of the remote management blocks.

FIG. 4 is a diagrammatic view of a Smart Block I/O device of the system of FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the remote management system and methods disclosed herein. The following detailed discussion of various alternative and preferred embodiments will illustrate the general principles of the invention with regard to management of remote cell tower sites of wireless communication networks. Other embodiments of the present invention suitable for other applications will be apparent to those skilled in the art given the benefit of this disclosure.

Traditional remote cell tower deployments typically include: NE management and access (e.g. Microwave, BTS, etc), complete site alarming, security, power, and environmental monitoring. However, certain markets, customers, and competitive situations suggest that there is a need for focused products to cover a more narrow range of functionality at a more convenient price. One such opportunity exists in the area of power management and monitoring. This is especially true in price-sensitive international markets, where power is often a significant problem area, and network funding is very tight.

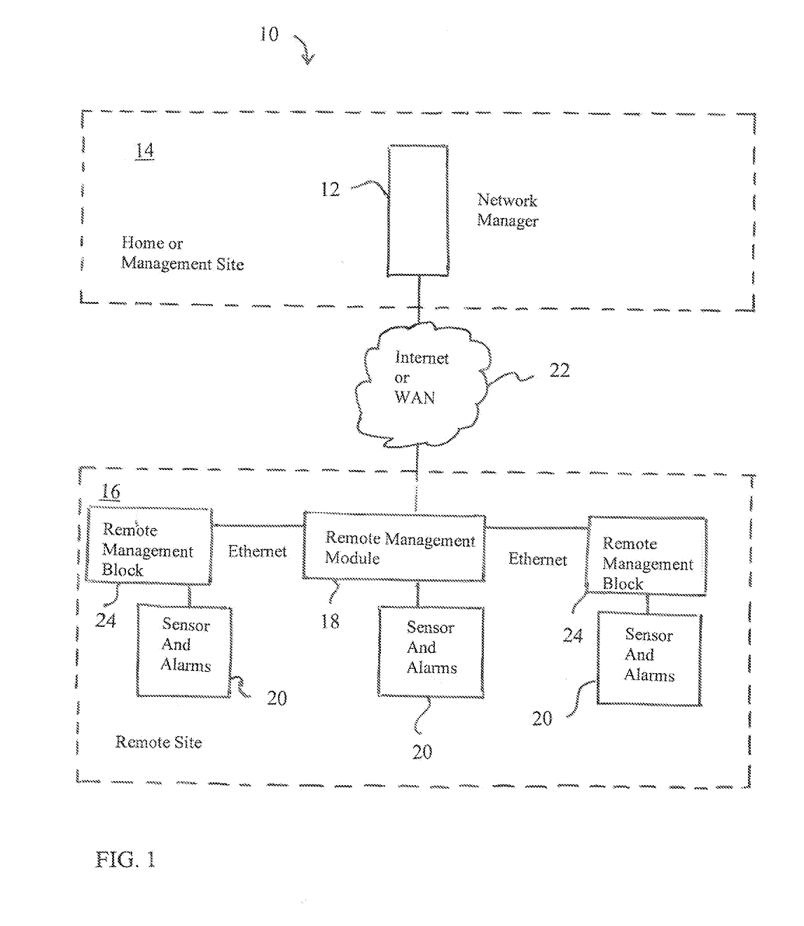

FIGS. 1 to 4 illustrate a management system for a remote cell tower site of a wireless communication network according to the present invention. The illustrated management system 10 includes a network manager 12 located at a home or management site 14 and at least one remote site 16 typically having a tower, antenna and related equipment. It is noted that while the illustrated management system 10 shows a single remote site 16, in practice there will typically be a plurality of remote sites 16 located over a wide area. The illustrated remote site 16 includes a remote management module (“RMM”) managed by the network manager 12 located at the home site 14. It is noted, however, that the remote site 16 can alternatively have any other suitable quantity of remote management modules 18 all in communication with and managed by the network manager 12. The remote management module 18 supports different types of measurements and alarms fed from downstream devices 20 associated with the equipment at the remote site 16.

The network manager 12 is located at the home site 14 and includes a computer system having a processor and memory configured to perform the management functions described herein. The computer system also includes suitable bi-directional communication means for communicating with the remote management module 18 at the remote site 16 via a wireless communication network 22 using Ethernet, T1/E1, and/or wireless communication options. Management software with a suitable user interface is operable with the computer system. The management portal can be Optima® Management Portal available from Kentrox, Inc., of Dublin, Ohio, but it is noted that any other suitable management software can alternatively be utilized. The Optima® Management Portal is a hybrid network management/element management software package used to monitor and provide management access to Kentrox, Inc, products deployed in the user's network. The management software preferably gives network operators a complete, 360 degree view and control of the remote site 16. The management software can provide preventative maintenance tools to help identify issues at the remote site 16 before they occur. The management software also preferably provides performance reporting to enable operators to view trending and availability of the remote sites 16. Truck rolls to the remote sites 16 can be eliminated because of the remote access, diagnostics, and control capabilities in the management software. The main functions of the management software include: performance management; event/alarm management; element management; remote access; site data collection and control; and software/upgrade management.

The illustrated system 10 includes two types active and separate hardware components at the remote site 16 which work together to implement the solution: an I/O collector or remote measuring block (“RMB”); and the remote management module 18 which operates as a host device for the remote measuring blocks 24. The remote measuring block 24 is sometimes herein referred to as the “Smart Block” I/O device. The illustrated remote measuring block 24 provides alarm termination/collection and is a PoE-powered I/O collector. The illustrated remote measuring block 24 communicates via a network connection to the remote management module 18. The illustrated network connection comprises a single Ethernet connection for transmitting data therebetween and transmitting power to the remote measuring device 24 from the remote management module 18. The Ethernet connection preferably utilizes frames compatible with off-the-shelf PoE capable Ethernet switches. The illustrated remote management module 18 is powered by 20-60 VDC and includes wireless, serial, and Ethernet interfaces and support for the remote measuring blocks 24. It is noted that while the illustrated remote site 16 includes a single remote management module 18 and two of the remote measuring blocks 24, any other suitable county of remote management modules 18 and remote measuring blocks 24 can alternatively be utilized.

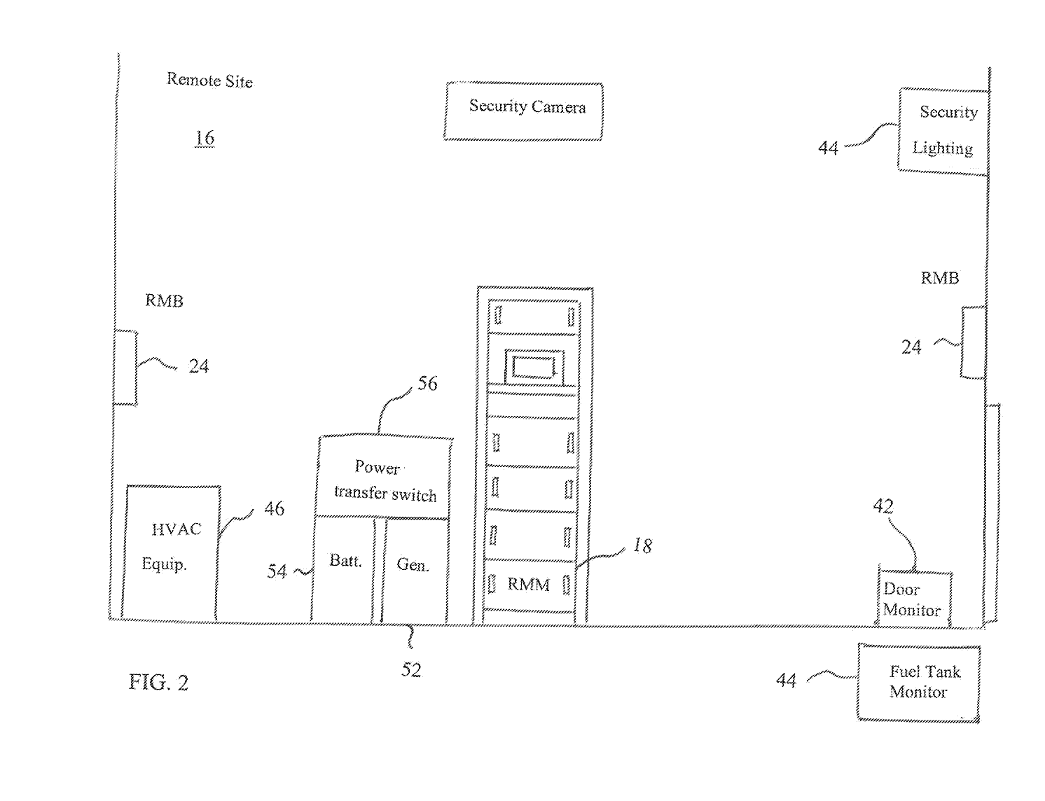

As best shown in FIG. 2, the illustrated remote management module 18 is adapted to be rack mounted and the illustrated remote measuring blocks 24 are adapted to be wall-mounted. This approach has several advantages. First, most site alarms and other measurement devices 20 are terminated at on-wall locations, while most intelligent systems reside in rack-mount locations. Thus, placing the remote management modules 18 and the remote measuring blocks 24 close to their respective termination points dramatically reduces cabling costs and installation time. Second, utilizing a single standard Ethernet connection between the remote management modules 18 and the remote measuring blocks 24 provides an extremely low-cost solution for alarm I/O collection which can be built and terminated rapidly in the field.

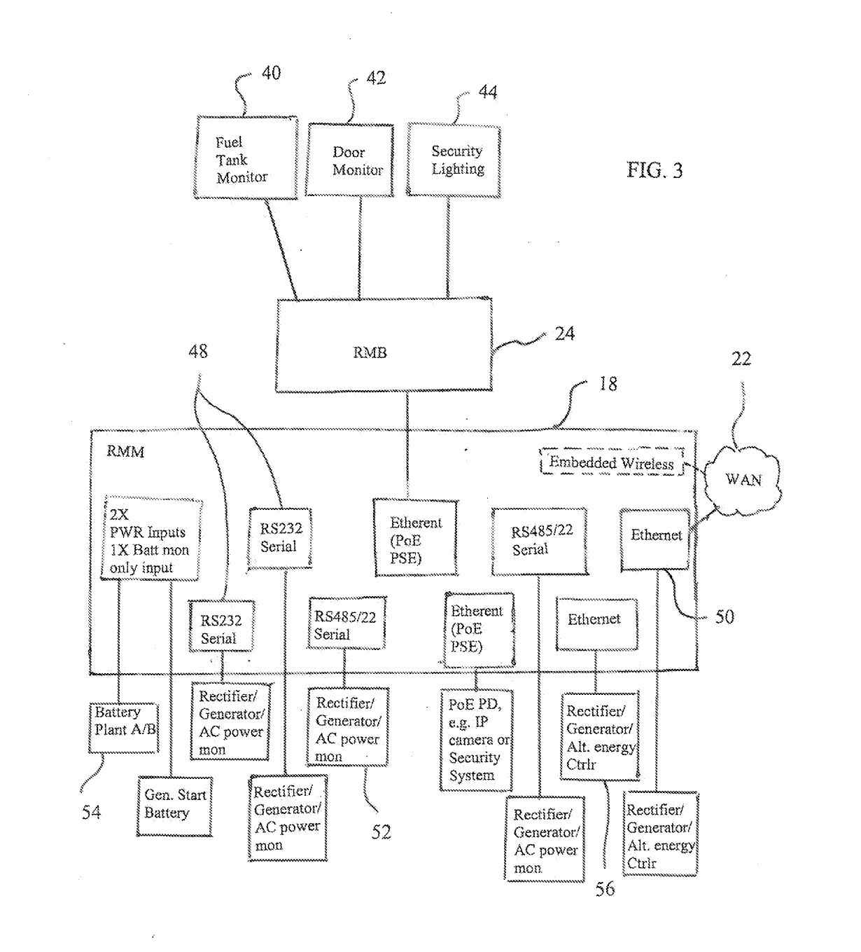

As best shown in FIG. 3, the illustrated remote management module 18 includes the following features: rack-mountable in a single RU; dimensions and mounting connections do not preclude wall-mounting; designed for CE compliance; supports dual-feed power supply with same polarity; supports voltage monitoring on each power supply input; supports a third voltage monitoring input with a range of +/−0-60 VDC for generator start battery monitoring applications; supports two Ethernet interfaces for network and/or NE connectivity (Ethernet 3 and 4); supports one 802.3af-compliant PoE (PSE) Ethernet interface for remote measuring block 24 and/or NE connectivity (this port operates with system power input voltages anywhere in the full +/−20-60 VDC range) (Ethernet 1 and 2); supports typical IPv4 networking configuration (addressing, subnet, gateway); supports bridging of all Ethernet ports; supports separation of Ethernet ports as routable interfaces; supports at least one secondary IP address for the bridge interface; supports Open VPN for secure connectivity to Connect-SCS aggregation systems; supports IP forwarding between connected subnets; supports initial turn-up and configuration via local Ethernet connection; supports 2 RS232 serial ports; supports 2 RS485/422 serial ports (non-overlapping with RS232 ports); supports an internal PCI express MiniCard interface; supports connection, management, and use of up to two remote measuring blocks 24; maintains and stores configuration related to managed remote measuring blocks 24, such that failed units require only physical replacement and minor remote management module 18 reconfiguration; supports northbound alarm and measurement table SNMP interfaces; supports methods for configuring deployed units in an automated fashion; supports IP traffic firewalling; supports simple DNAT/PAT and masquerade functionality; supports SNMP proxy functionality; supports NTP (client); supports DHCP (server) functionality; supports HTTP and HTTPS protocols; supports configurable server port numbers for applicable network services (e.g. Telnet, HTTPS, SNMP; supports up to 10 SNMP managers; supports an application environment, to support development of custom features by Kentrox applications engineering and service personnel; supports a CDMA/EVDO, GSM/GPRS/UMTS/HSPA modems; allows for installation of a GSM SIM module in <5 minutes with common hand-tools; and supports terminal server functionality for asynchronous serial interfaces (TCP port for cut-thru access shall be configurable). The illustrated remote management module 18 includes a serial console port that externally accessible. The operational temperature range of the illustrated remote management module 18 is −30 to +60 C. The illustrated remote management module 18 does not contain a fan. The illustrated remote management module 18 supports a Python application environment. Installation of a Python package on the illustrated remote management module 18 requires a special “key” to be embedded in the script package.

The remote management module 18 can implement a measurement table as described in U.S. patent application Ser. No. 12/950,265, the disclosure of which is expressly incorporated herein in its entirety by reference. The measurement table can be implemented as a native component of the remote management module 18 or as an external component, e.g. a script on an extend card. The illustrated remote management module 18 includes an auto sensing, re-configurable Ethernet port and is configured for automatic discovery of the remote measuring block 18 to minimize manual configuration. Thus configurations of the measurements and alarms can be stored on the remote management module 18 and automatically downloaded to a new remote measuring block 24 upon replacement of a failed our outdated remote measuring block 24. The illustrated remote management module 18 is also configured for storing operating software of the remote measuring block 24 and automatically downloading software updates to the remote measuring block 24 upon updating or replacement.

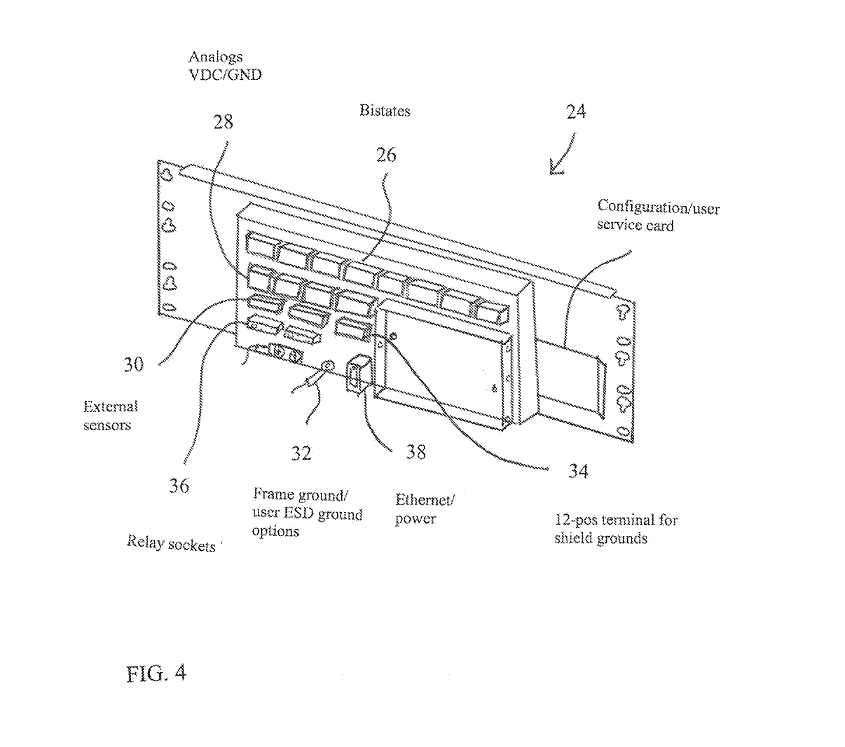

As best shown in FIG. 4, the illustrated remote measuring block 24 has a plurality of external sensor interfaces available via punch-down connections including connectors for bistates 26, connectors for analogs 28, connectors external sensors 30, and relay sockets 32. Thus the illustrated remote measuring block 24 provides industry standard alarm connectivity. The illustrated remote measuring block 24 further includes a 12-position terminal 34 for grounding up to 12 CAT5 cable shields (8 analogs+4 sensor connections) and a terminal 36 frame ground to provide positive chassis grounding. The illustrated remote measuring block 24 also provides an Ethernet port 38 for connection to the network, and thus is capable of being managed by the remote management module 18.

The illustrated remote measuring block 24 has the ability to monitor external sensors. By utilizing external sensors 20, the I/O count of the remote measuring block 24 is easily scalable. One of the illustrated remote measuring blocks 24 is connected to devices associated with a fuel tank level monitor 40, an external door monitor 42, and a security lighting monitor 44. The other of the illustrated remote measuring blocks 24 is connected to sensors associate with HVAC equipment 46. It is noted that the illustrated external sensors are exemplary only and the remote measuring blocks 24 can be connected to any other quantity and/or type of external sensors as desired for a particular application. The remote measuring block 24 can also include internal sensors. For example, the illustrated remote measuring block 24 includes an internal temperature sensor and an internal humidity sensor to alleviate the need for at least one external sensor in the majority of applications.

The illustrated remote measuring block 24 includes the features: wall-mountable; dimensions and mounting connections allows rack-mounting in 3RU or less; designed for CE compliance; supports an RJ45 Ethernet connection; operates as an 802.3af-compliant PoE powered device; includes punch-down connections for all discrete, analog, voltage output, and control relay outputs points; supports 64 bistate inputs; supports 4 current (4-20 mA) analogs; supports a +24 VDC output; and supports four analog inputs capable of measuring 0-10 VDC with ˜0.1 VDC resolution.

As best shown in FIG. 3, the illustrated remote management module 18 also has the ability to directly monitor external sensors. This eliminates the need for a remote measuring block 24 to be located near the remote management module 18. The illustrated remote management module 18 has a plurality of external sensor interfaces available via punch-down connections including serial connectors 48 and Ethernet ports 50. The illustrated remote measuring blocks 24 is connected to devices associated with a fuel tank level monitor 40, an external door monitor 42, and a security lighting monitor 44. The other of the illustrated remote management module 18 is connected to sensors associate with an auxiliary power generator 52, auxiliary batteries 54, and a power transfer switch 56. It is noted that the illustrated external devices are exemplary only and the remote management module 18 can be connected to any other quantity and/or type of external sensors/devices as desired for a particular application.

From the foregoing disclosure and detailed description of certain preferred embodiments, it is apparent that the above described system drastically reduces the amount of cabling needed at the remote site 16 because the remote measuring blocks 24 are located near sensor terminations and are connected to the remote management module 18 with a single Ethernet connection.. It is also apparent that the system reduces time and cost of maintenance because the remote measuring blocks 24 can be replaced without reconfiguration because the remote management module 18 stores configurations and operating software for the remote measuring blocks 24 and automatically downloads the information to a new remote measuring block 24 upon replacement of a failed or outdated remote measuring block 24.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention.

What is claimed is:

1. A system for monitoring a remote site comprising, in combination:
a remote management module including a processor and memory configured to receive definitions of measurements and alarms to be collected at the remote site and to store the definitions of the measurements and alarms, and a communication system for reporting collected measurements and alarms to upstream systems located away from the remote site;
at least one remote measuring block including a processor and memory configured to receive from the remote management module at least one of the definitions of measurements and alarms to be collected at the remote site and to store the at least one of the definitions of the measurements and alarms, and a plurality of port connectors for communicating the processor of the remote measuring block with downstream collection devices that collect measurements and alarms at the remote site; and
a networking connection between the remote management module and the remote measuring block for transferring data therebetween.

2. The system according to claim 1, wherein the remote management module further includes a plurality of port connectors for communicating the processor of the remote management module with downstream collection devices that collect measurements and alarms at the remote site;

3. The system according to claim 1, wherein the networking connection is an Ethernet connection.

4. The system according to claim 1, wherein the Ethernet connection utilizes frames compatible with off-the-shelf PoE capable Ethernet switches.

5. The system according to claim 1, wherein the networking connection is the only electronic connection between the remote management module and the remote measuring block.

6. The system according to claim 1, wherein the networking connection powers the remote measuring block

7. The system according to claim 1, wherein the remote measuring block provides industry standard alarm connectivity.

8. The system according to claim 1, wherein the remote management module is configured for automatic discovery of the remote measuring block to minimize manual configuration.

9. The system according to claim 1, wherein the remote management module is configured for storing operating software of the remote measuring block and automatically downloading software updates to the remote measuring block.

10. The system according to claim 1, wherein the remote management module includes an auto sensing, re-configurable Ethernet port.

11. The system according to claim 1, wherein the remote site is a cell tower site of a wireless telecommunication network.

12. A system for monitoring a remote site comprising, in combination:
a remote management module including a processor and memory configured to receive definitions of measurements and alarms to be collected at the remote site and to store the definitions of the measurements and alarms, and a communication system for reporting collected measurements and alarms to upstream systems located away from the remote site;
at least one remote measuring block including a plurality of port connectors for connection to downstream collection devices that collect measurements and alarms at the remote site;
wherein the remote management module and the remote measuring block are packaged as separate units and are at separate locations of the remote site; and
a networking connection between the remote management module and the remote measuring block transferring data therebetween.

13. The system according to claim 12, wherein the remote measuring block further includes a processor and memory configured to receive from the remote management module at least one of the definitions of measurements and alarms to be collected at the remote site and to store the at least one of the definitions of the measurements and alarms.

14. The system according to claim 12, wherein the remote management module further includes a plurality of port connectors for communicating the processor of the remote management module with downstream collection devices that collect measurements and alarms at the remote site;

15. The system according to claim 12, wherein the networking connection is an Ethernet connection.

16. The system according to claim 15, wherein the Ethernet connection utilizes frames compatible with off-the-shelf PoE capable Ethernet switches.

17. The system according to claim 12, wherein the networking connection is the only electronic connection between the remote management module and the remote measuring block.

18. The system according to claim 12, wherein the networking connection powers the remote measuring block

19. The system according to claim 12, wherein the remote measuring block provides industry standard alai in connectivity.

20. The system according to claim 12, wherein the remote management module is configured for automatic discovery of the remote measuring block to minimize manual configuration.

21. The system according to claim 12, wherein the remote management module is configured for storing operating software of the remote measuring block and automatically downloading software updates to the remote measuring block.

22. The system according to claim 12, wherein the remote management module includes an auto sensing, re-configurable Ethernet port.

23. The system according to claim 12, wherein the remote site is a cell tower site of a wireless telecommunication network.

24. A system for monitoring a remote site comprising, in combination:
a remote management module including a processor and memory configured to receive definitions of measurements and alarms to be collected at the remote site and to store the definitions of the measurements and alarms, and a communication system for reporting collected measurements and alarms to upstream systems located away from the remote site;
at least one remote measuring block including a processor and memory configured to receive from the remote management module at least one of the definitions of measurements and alarms to be collected at the remote site and to store the at least one of the definitions of the measurements and alarms, and a plurality of port connectors for communicating the processor of the remote measuring block with downstream collection devices that collect measurements and alarms at the remote site;
a networking connection between the remote management module and the remote measuring block for transferring data therebetween; and
wherein all configurations for the devices connected to the remote measuring block are stored in the remote management module so that the remote measuring block can be replaced without reconfiguration.

25. The system according to claim 24, wherein the remote management module is configured for storing operating software of the remote measuring block and automatically downloading software updates to the remote management module when the remote measuring block is upgrade or replaced.

26. The system according to claim 25, wherein the remote site is a cell tower site of a wireless telecommunication network.
